(19) United States
(12) Patent Application Publication
(10) Pub. No.: US 2007/0079634 A1
(43) Pub. Date: Apr. 12, 2007

(54) Mold cooling for I.S. machine

(76) Inventors: Thomas Bewer, Thalwil (CH); Wolfgang Anheyer, Neuss (DE)

Correspondence Address: Emhart Glass Research, Inc., 89 Phoenix Avenue, P.O. Box 1229, Enfield, CT, 06083-1229, US

(21) Appl. No.: 11/244,990

(22) Filed: Oct. 6, 2005

(51) Int. Cl. C03B 9/38; C03B 11/12; C03B 13/00; C03B 15/00

(52) U.S. Cl. 65/356

(57) ABSTRACT

A mold assembly for use in a glassware manufacturing machine comprising two mold members each including a plurality of cooling passages extending vertically therethrough from a lower end face to an upper end face and at least one twisted metal strip.

### BACKGROUND OF THE INVENTION.

In the production of glass containers on the well known I.S. type machine, glass is formed into a parison in a blank mold and then blown into a bottle in a blow mold, each of the blank mold and the blow mold comprising two mold members movable between a closed position, in which they define a mold cavity, and an open position. Both the blank mold and the blow mold are cooled in the operation of the machine and such cooling is often carried out by providing the mold members with cooling passages extending axially therethrough from a lower end face to an upper end face of each mold member, and providing cooling air to these passages.

When the cooling passages in the mold members are provided with cooling air from a plenum chamber, it is possible to calculate the cooling effect of a cooling passage, and thus to determine a pattern of cooling passages which will give the required cooling. However, it is sometimes desirable to modify the cooling of a mold member, but this usually requires a modification of the cooling passages by way of addition or removal of cooling passages which modification is not readily reversible.

### OBJECT OF THE INVENTION

It is one of the objects of the present invention to provide an improved method of cooling a mold member.

It is another of the objects of the present invention to provide an improved mold for use in a glassware-manufacturing machine.

Other objects and advantages of the present invention will become apparent from the following portion of this specification and from the accompanying drawings, which illustrate a presently preferred embodiment incorporating the principles of the invention.

### BRIEF DESCRIPTION OF THE DRAWINGS

FIG. 1 shows a mold member having axially extending cooling passages;

FIG. 2 shows a twisted metal strip;

FIG. 3 shows, diagrammatically a cooling passage with a twisted metal strip inserted therein; and

FIG. 4 shows, diagrammatically a cooling passage with a twisted metal strip inserted therein and having a diffuser portion at its upper end.

### BRIEF DESCRIPTION OF THE PREFERRED EMBODIMENT

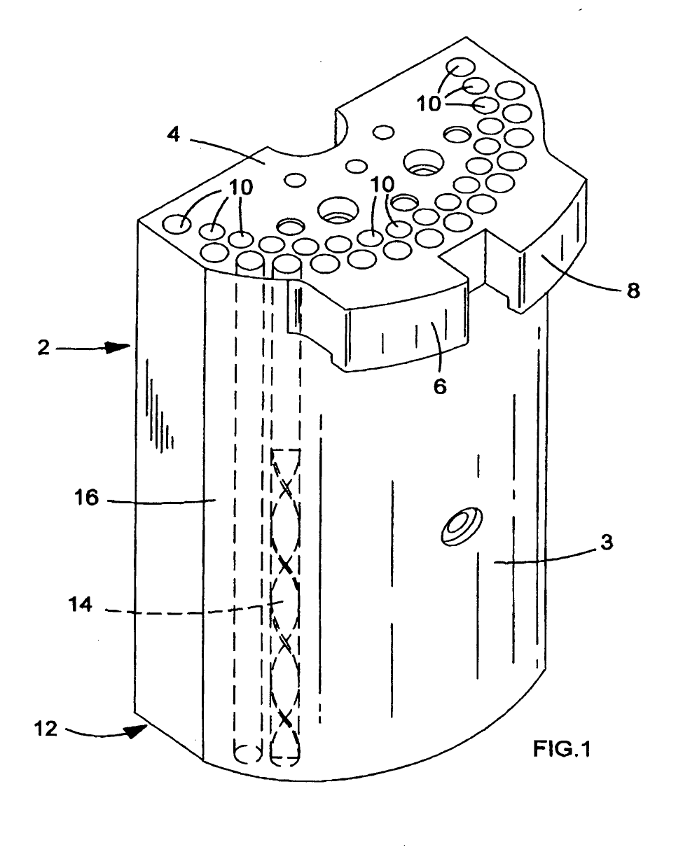

FIG. 1 shows a mold member 2 for use in an I.S. glass-forming machine. This mold, together with a corresponding mold member, provides a mold cavity of a blank or blow mold in an I.S. machine. A blank cavity defines a portion of a parison formed in the blank station of the machine, and a blow cavity defines a portion of a bottle formed in the blow station of the machine. The mold member 2 is generally half cylindrical in shape and comprises a generally cylindrical outer surface 3, a mold recess [not shown] and an upper end face 4 adjacent to which are two flange lugs 6 and 8 by which the mold member may be supported in the machine. The mold member 2 comprises an array of straight cooling passages 10 which extend axially through the mold member from its upper end face 4 to a lower end face 12.

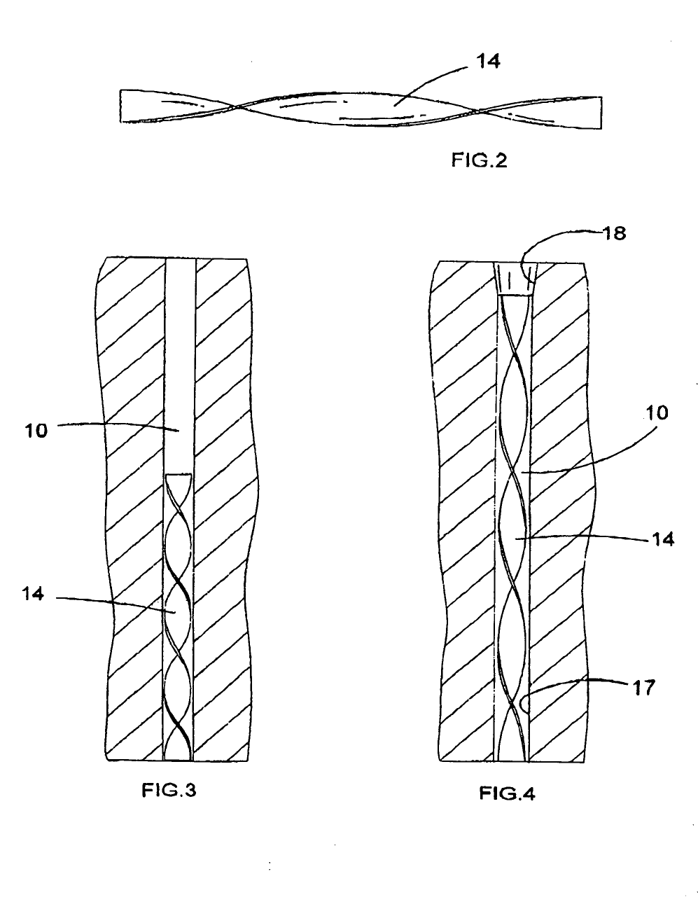

When the mold member 2 is in use in an I.S. machine, compressed air from a plenum chamber is provided at the lower ends of the cooling passages 10 to cool the mold member. In general, the passages 10 are provided in the mold member 2 in a pattern and of a size calculated to provide the desired cooling. However, on occasion it is found that in the production of a particular container, the calculated cooling is inadequate. Such inadequacy [both in the horizontal and the vertical temperature profile in the mold member] can be remedied by modifying the pattern of cooling passages, but such modification is usually irreversible and the mold member 2 cannot readily be returned to its original configuration. When air passes through a cooling passage in a mold, the flow of air is generally turbulent, but a laminar boundary layer is formed which is in contact with the material of the mold and which gets very hot. We have found that by providing an appropriate insert in the cooling passage, this boundary layer can be disrupted and the hot air from the boundary layer, mixed with the cooler air of the center of the air stream, thus to give a more effective extraction of heat from the mold. According to the invention, the mold member 2 is modified from its original configuration by the positioning (friction fit) in one or more of the cooling passages of a twisted metal strip 14. Such a strip with one 360° twist is shown in FIG. 2.

The twisted metal strip may have one or more, preferably two 360° twists.

The length of the strip is related to the amount of twist. The strip may extend for substantially the length of the cooling passage, but we prefer to use a strip with two 360° twists extending for about half the length of the cooling passage in which it is inserted. If the amount of twist is too great, the resistance to the air flow is such that the cooling effect is reduced rather than increased. Preferably, the strip has at least one full 360° twist.

The strip is preferably a close fit in the cooling passage, and of a material, which has the same or slightly greater coefficient of expansion as the material of the mold member.

When air passes through an unobstructed passage 10, it shows turbulent flow, but with a laminar boundary layer in contact with the wall of the cooling passage. This results in the outer portion of the airflow, which is in contact with the hot metal of the mold member, getting hotter than the central portion of the airflow. In a cooling passage 10, with a twisted metal strip 14 positioned in it [as shown in FIG. 3], this laminar flow of the boundary layer is disrupted and as a result more heat is extracted from the mold member.

The strip 14 is of mild steel and about 0.2 mm in thickness. Strips of up to 0.5 mm in thickness can be used. Such material can readily be twisted. Copper could also be used. The strip 14 extends for just over half the length of the passage 10, is formed with two 360° twists, and is a close fit in the passage 10.

We have found that air passing through a passage 10 with the strip 14 in position extracts approximately 15% more heat from the mold than similar air passing through an unmodified passage 10. We prefer to use a strip 14 having two 360° twists. If the amount of twist is too great, the resistance to the air flow is such that the cooling effect is reduced rather than enhanced. In the case of a strip having one full 360° twist, approximately 6% more heat is extracted than by similar air passing through an unmodified passage. By selection of strips of appropriate lengths, it is possible to modify the vertical temperature profile in the mold member.

FIG. 4 shows a cooling passage 10 in a mold member, which passage has a lower portion 17 of small diameter and a shorter tapered upper portion 18 extending to the upper end face 4. The angle of the taper is about 7°. This tapered portion 18 acts as a diffuser. Provision of a diffuser increases the heat extracted by the air passage by up to about 20%. FIG. 4 shows a passage 10 having a diffuser which is also provided with a strip 14, which extends the length of the lower portion 17, and again, is formed with two 360° twists. In this case, the heat extracted by the air passage 10 is increased by about a further 20%.

It will be understood that while we have described the invention in relation to a blow mold, corresponding use of inserted strips may be used with a blank mold having axial cooling passages.

1. A mold for use in a glassware forming machine having a blank station and a blow station, wherein a pair of molds define the sidewall surface of a parison/bottle in the blank/blow station of the I.S. machine, said mold having a lower end face, an upper end face and a plurality of cooling passages extending vertically between the lower and upper end faces, comprising a twisted elongated metal strip located within at least one of said plurality of cooling passages.

2. A mold according to claim 1 in which said metal strip comprises two 360° twists.

3. A mold according to claim 1 in which said metal strip comprises one 360° twist.

4. A mold according to claim 1 in which said metal strip is between 0.2 and 0.5 mm in thickness.

5. A mold according to claim 4 in which said-metal strip is of mild steel.

6. A mold according to claim 1 in which said metal strip extends for substantially half the length of the passage.

7. A mold according to claim 1 in which the said one of the cooling passages comprises a portion adjacent the upper end face which is tapered to a greater diameter than the rest of the passage and acts as a diffuser and in which the metal strip does not extend into said tapered portion.

8. A method of modifying the cooling of a mold member of an I.S. machine provided with cooling passages vertically extending axially therethrough from a lower end face to an upper end face of the mold member comprising the step of inserting into at least one of the cooling passages an elongated, twisted metal strip which is a close fit in the passage.

9. A method according to claim 8 wherein the strip comprises two 360° twists.

10. A method according to claim 9 in which the metal strip extends for substantially half the length of the passage.
